(19) United States
(12) Patent Application Publication
(10) Pub. No.: US 2007/0174257 A1
(43) Pub. Date: Jul. 26, 2007

(54) SYSTEMS AND METHODS FOR PROVIDING SORTED SEARCH RESULTS

(76) Inventor: BRUCE THOMAS HOWARD, Canton, GA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/622,624

(22) Filed: Jan. 12, 2007

Related U.S. Application Data
(60) Provisional application No. 60/759,827, filed on Jan. 18, 2006.
(60) Provisional application No. 60/759,896, filed on Jan. 18, 2006.

(51) Int. Cl. G06F 17/30

(52) U.S. Cl. 707/3

(57) ABSTRACT

Systems and methods for providing sorted search results are disclosed. An exemplary method comprises receiving a search request to return results based on at least one keyword, sorting the returned results into at least two result groups based on sorting criteria, and outputting the results to a display device such that the result groups are displayed differently in a user interface. In one version the sorted results of at least two result groups are simultaneously displayed in different portions of a user interface and, in another version, indicators for the at least two result groups are simultaneously displayed in different portions of a user interface. Sorting may be based on any desired criteria such a document type, URL, secure or nonsecure web site, etc.

### CROSS-REFERENCE TO RELATED APPLICATIONS

This application claims priority to, and the benefit of, U.S. Provisional Patent Application entitled “SEARCH ENGINE HAVING SUB-DIVIDED SEARCH RESULTS,” assigned Ser. No. 60/759,827 and filed on Jan. 18, 2006, and U.S. Provisional Patent Application entitled “SEARCH ENGINE HAVING DIVIDED SEARCH RESULTS,” assigned Ser. No. 60/759,896 and filed on Jan. 18, 2006, both of which are incorporated herein by reference in their entirety.

### BACKGROUND

1. Technical Field

The present disclosure generally relates to search engines, and more specifically, to the generation and output of search results by a search engine.

2. Description of the Related Art

A search engine is an information retrieval system which finds and displays relevant information stored on one or more computers or computer systems. While a search engine may find information stored on a single computer, a common usage of a search engine is to find information stored on a system of computers which are typically linked together in a network, such as, for example, the Internet. Once certain information is found and displayed, a search engine may then expediently redirect a user (searcher) to a specific document or network location.

A search engine may, for example, accept one or more keywords as input for a search request. Typically, keywords relate to a specific topic or area of interest of a user and could be given as a word or a phrase, among other possibilities, which are expected to be found as content within a document. The search engine then retrieves and displays a list of search results responsive to the search request.

U.S. patent Publication US2004/0128282A1 by Kleinberger, et al., discloses a search system and method whereby the searcher may enter preferences in addition to the search criteria. Once the search results are obtained based upon the search criteria, the results are organized into a hierarchy of categories based upon some defining characteristic for each category, such as by analyzing the textual material to find the most important common subjects existing among the search results. The search results in a category are then organized into a hierarchy of sub-categories based upon some defining characteristic for each sub-category in that category. This process of hierarchical categorization occurs automatically, is transparent to the searcher, and is not subject to control or direction by the searcher. The searcher is thus denied an opportunity to specify the categories, the sub-categories, or the defining characteristics in a manner which is meaningful to the searcher or even logical to the searcher. As a result, the searcher may be presented with a display of hierarchical categories which is frustrating or even useless to the searcher. In order to find a desired result, the searcher is forced into a multi-step process of looking through possibly the entire hierarchy of categories in order to identify the category most likely to have the desired information, opening that category, looking through possibly the entire hierarchy of sub-categories of that category in order to identify the sub-category most likely to have the desired information, and opening that sub-category. Only then can the search begin to determine if any of the search results in that sub-category are useful. If not, the searcher must pick another sub-category, or even another category, and repeat the process. Even so, the desired result may not be present in the sub-categories viewed by the searcher or anywhere within the hierarchy. As a result, the searcher may never find the desired information or know whether the desired information is even present. The searcher may thus find this technique difficult, frustrating, time-consuming, and ultimately useless.

### SUMMARY

One embodiment provides a method for providing sorted search results which includes receiving a search request to return a result set based on at least one keyword, sorting the returned result set into at least two result groups based on sorting criteria, and outputting the result groups to a display device such that at least a portion of each of the result groups is displayed differently in a user interface.

Another embodiment provides a computer readable medium having a computer program which comprises logic configured to receive a search request to return a result set based on at least one keyword, logic configured to sort the returned result set into at least two result groups based on sorting criteria, and logic configured to output the result groups to a display device such that at least a portion of each of the result groups is displayed differently in a user interface.

Another embodiment provides a search engine system which includes means for receiving a search request to return a result set based on at least one keyword, means for sorting the returned result set into at least two result groups based on sorting criteria, and means for outputting the result groups to a display device such that at least a portion of each of the result groups is displayed differently in a user interface.

In one embodiment at least a portion of the sorted search results of one result group is displayed simultaneously with, but in a different portion of a user interface than, a portion of the sorted search results of another result group.

In another embodiment a result group includes an indicator and at least some of the sorted search results, and at least the indicator of one result group is displayed simultaneously with, but in a different portion of a user interface than, the indicator of another result group.

### BRIEF DESCRIPTION OF THE DRAWINGS

FIG. 1 is a block diagram of an exemplary search engine that can be used for providing sorted search results.

FIG. 2 is a block diagram depicting an exemplary computing system that can be used to implement the search engine components of FIG. 1.

FIG. 3 is a block diagram depicting of an embodiment of the search engine of FIG. 1 in a distributed environment.

FIG. 4 is an exemplary data flow diagram depicting an overview of the operation of the search engine of FIG. 1.

FIG. 5 depicts a continuation of the exemplary data flow diagram of FIG. 4.

FIG. 6 depicts a continuation of the exemplary data flow diagrams of FIGS. 4 and 5.

FIG. 7 depicts a continuation of the exemplary data flow diagrams of FIGS. 4-6.

FIG. 8 depicts an exemplary graphical user interface that can be displayed based on the output of embodiments of the search engine that can be used for providing sorted search results.

FIG. 9 depicts another exemplary graphical user interface that can be displayed based on the output of embodiments of the search engine that can be used for providing sorted search results.

FIG. 10 depicts another exemplary graphical user interface that can be displayed based on the output of embodiments of the search engine that can be used for providing sorted search results.

FIG. 11 depicts another exemplary graphical user interface that can be displayed based on the output of embodiments of the search engine that can be used for providing sorted search results.

FIG. 12 is a flow chart of an exemplary process for providing sorted search results.

### DETAILED DESCRIPTION

Systems and methods for displaying search results are described herein. For example, according to embodiments of the present disclosure, a search request is received and a result set is returned based on at least one keyword in the search request. The objects in the result set are sorted into at least two result groups based on, for example, a plurality of logically relatable objects. The objects in a result group are then ranked to produce a set of ranked results for that result group. The sets of ranked results can then be output such that they are displayed differently in a user interface. Preferably, but not necessarily, the ranked results are displayed simultaneously in, but in different portions of, a user interface. For convenience of discussion herein, performing an action on the objects 108 in a result set 118 is referred to as performing the action on the result set 118. For example, sorting the objects 108 in the result set 118 is simply referred to as sorting the result set 118.

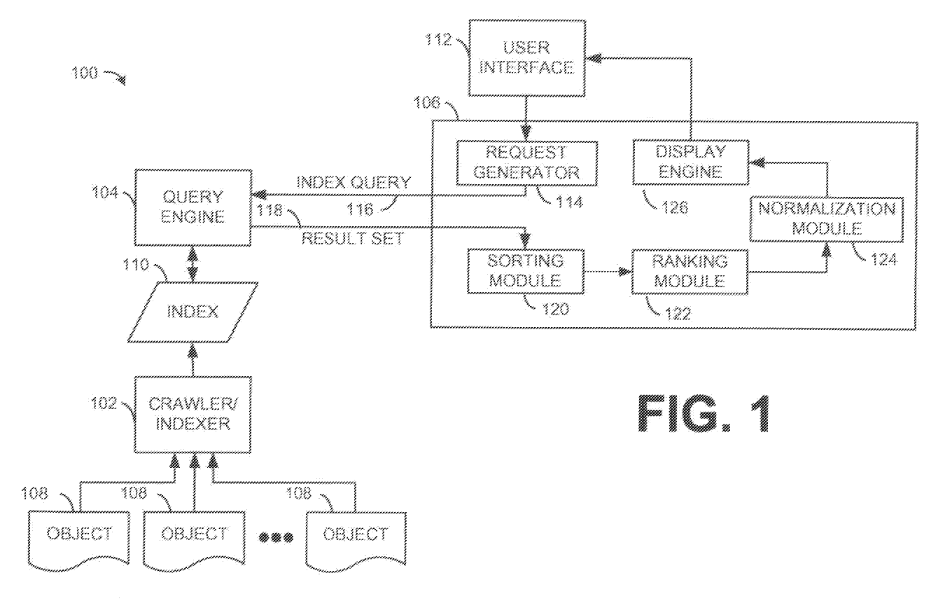

FIG. 1 is a block diagram depicting a search engine 100 that can be used for, among other purposes, providing sorted search results based on a user search request. Search engine 100 is an information retrieval system that is designed to find and display information, usually about web-based documents or file storage locations, stored on one or more computers or on a network or system of computers. Thus, search engine 100 can be a network search engine which searches for and finds information located on a computer network to include, for example, the Internet, the World Wide Web, a wide area network (WAN), a local area network (LAN), an intranet, an enterprise network, or a personal network. Search engine 100 can also be a dedicated search engine used to find information stored on a single computer, such as a desktop personal computer (PC) or a personal digital assistant (PDA).

Generally, search engine 100 comprises a crawler/indexer 102, a query engine 104 and a result display system 106. Crawler/indexer 102 can be configured to search for and retrieve accessible objects 108, which could be various types of files, documents and media files, among other information. According to some embodiments in which crawler/indexer 102 is a web site crawler, the crawler/indexer 102 is configured to retrieve discovered web pages and to traverse links to other web pages in order to populate index 110. The contents of each web page, document and/or media file can then be analyzed to determine how it should be indexed. The index 110 can, for example, store a title, headings, metatags, source content, file names, uniform resource locator (URL) information, and other information associated with, or derived from, the various discovered objects 108. This information is thus stored in index 110 for use in providing search results responsive to queries.

Result display system 106 can be logically viewed as a number of executable modules for requesting search results, sorting the results, ranking the results, normalizing the results, and/or formatting the results such that they can be displayed in a user interface 112. Specifically, request generator 114 receives a search request provided from user interface 112 and formats the search request into an appropriate format, depicted as index query 116, for transmission to query engine 104. Request generator 114 then transmits index query 116 to query engine 104. Query engine 104 is configured to receive index query 116, access the index 110, and generate a result set 118 based on the index query 116. Result set 118 comprises a listing of the objects 108 (stored in index 110) that satisfy the index query. The result set 118 generally includes information about the actual object 108 as well as a location for finding the object 108. For example, the location could be a directory path and file name on a hard drive or it could be a URL on the Internet. The result set 118 may also include other information found in the index about the object 108 such as, but not limited to, content (i.e., cached information), title, metatags, and file type.

In one embodiment, result display system 106 includes one or more of a sorting module 120, a ranking module 122, a normalization module 124, and a display engine 126. In general, sorting module 120 is configured to receive the result set 118 and to sort the result set 118 into distinct result groups. In other words, sorting module 120 is configured to classify, sort or group the result set 118 into two or more result groups. Ranking module 122 ranks the objects 108 in a result group to determine the most relevant results within that result group. This is preferably, but not necessarily, performed for each result group. Normalization module 124 is configured to eliminate or reduce redundant results in each result group. Display engine 126 is configured to output the search results in a desired format such that the sorted, ranked, and normalized result groups can be displayed to the user through user interface 112.

Although FIG. 1 depicts each of sorting module 120, ranking module 122, and normalization module 124 as performing actions on result set 118, it should be understood that certain embodiments of search engine 100 may not include all of these modules. For example, some embodiments of search engine 100 may include only a subset of sorting module 120, ranking module 122, and normalization module 124. According to one embodiment, the result set 118 is sorted using sorting module 120, ranked by ranking module 122, and then output for display by display engine 126 without the results being processed by normalization module 124. Furthermore, it should be understood that one or more of sorting module 120, ranking module 122, and normalization module 124, if present, can be configured to process the result set 118 before another module. For example, result set 118 could be normalized and then the normalized results are passed to sorting module 120 and/or ranking module 122.

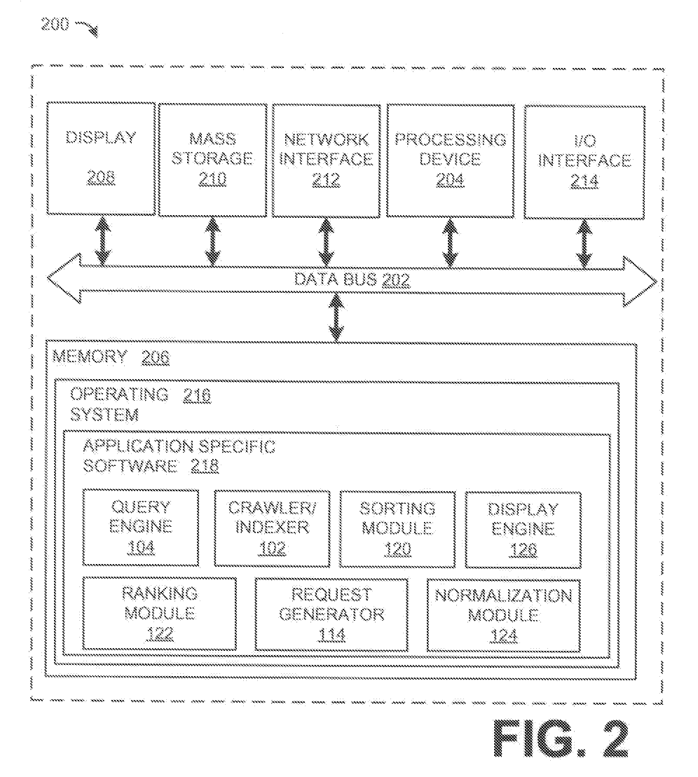

Search engine 100 can also be implemented using one or more computing systems. For example, FIG. 2 depicts a block diagram of an exemplary computing system 200 that can be used to implement the described systems and methods for providing sorted search results. Generally, computing system 200 may be one of a wide variety of wired and/or wireless computing systems, such as a desktop computer, laptop computer, PDA, handheld or pen based computer, dedicated server computer, multiprocessor computing device, cellular telephone, or embedded appliance.

Without regard to a specific arrangement, computing system 200 can, for instance, comprise a data bus 202 which may connect a processing device 204, memory 206, display 208, mass storage 210, network interface 212, and an input/output interface 214. Although not depicted, it should be understood that computing system 200 may also include a number of other computing devices, such as but not limited to, user input devices or other peripherals.

A processing device 204 can include any custom made or commercially available processor, a central processing unit (CPU) or an auxiliary processor, a microprocessor (such as, but not limited to, in the form of a microchip), a macroprocessor, one or more application specific integrated circuits (ASICs), a plurality of suitably configured digital logic gates, and other well known electrical configurations comprising discrete elements, both individually and in various combinations, to implement the overall operation of the computing system.

The input/output interface 214 provides for a wide variety of possible interfaces for the input of data to and the output of data from computing system 200. For example, where computing system 200 comprises a device, such as, but not limited to, a personal computer, a server computer, or a handheld computer (e.g., PDA, mobile telephone, etc.), this device may receive input from, for example, a keyboard, a mouse, a touch-sensitive screen, a set of function keys or buttons, or a stylus, among other possibilities. Input/output interface 214 also enables the virtual exchange of data through a network, such as, but not limited to, a client/server environment.

Memory 206 preferably includes one or more volatile memory elements (e.g., Random Access Memory (RAM), such as DRAM, SRAM, etc.) and nonvolatile memory elements (e.g., ROM, hard drive, tape, CD-ROM, DVD, DVD-ROM, etc.). Typically, memory 206 comprises a native operating system 216 which is able to host one or more native applications, emulation systems, or emulated applications. For example, as depicted by FIG. 2, operating system 216 hosts application specific software 218 which, collectively, comprises query engine 104, crawler/indexer 102, sorting module 120, display engine 126, ranking module 122, request generator 114, and/or normalization module 124.

Although FIG. 1 depicts an exemplary single search engine 100 and FIG. 2 depicts an exemplary single computing system 200, it should be understood that the present invention is not so limited. For example, individual components, including software modules and/or hardware components of search engine 100 and/or of computing system 200, can be distributed across a network, which can, for example, provide service to a wider base of users. Also, components can be duplicated within one or more computer systems, which can, for example, provide for redundancy and higher speeds.

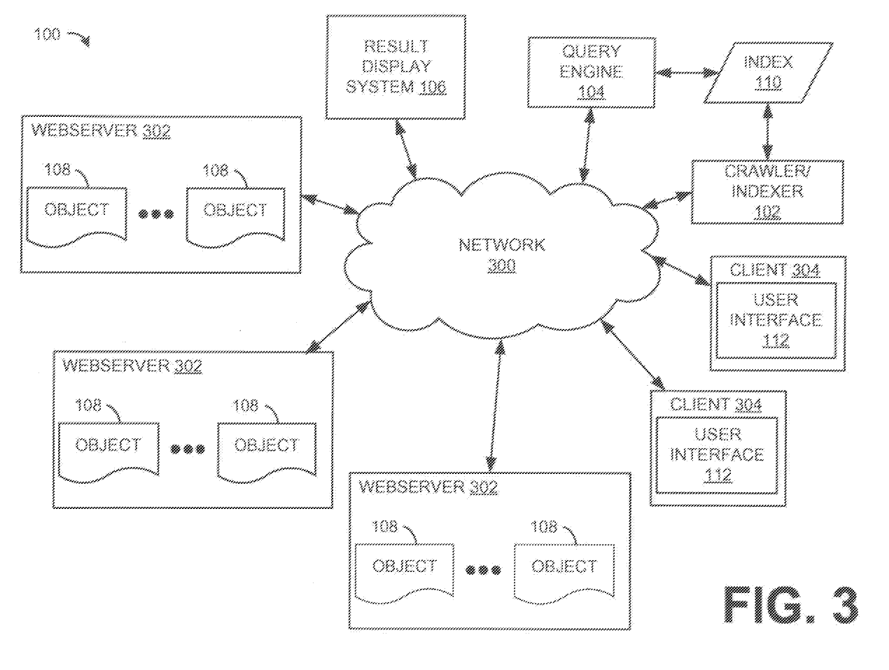

For example, as shown in FIG. 3, an embodiment of a search engine 100 is depicted in which a plurality of networked computer systems perform the functionality of, for example, query engine 104, crawler/indexer 102, sorting module 120, display engine 126, ranking module 122, request generator 114, and/or normalization module 124. These computer systems can be distributed and connected across a network 300, which could include one or more communications medium which provides for the transfer of data. The communications medium may include, for example, the Internet, a LAN, a WAN, or a combination of one or more thereof. A plurality of web servers 302 and web clients 304 can also be connected to network 300. Web servers 302 can host, publish, or serve any number of objects 108 to any remote node connected to network 300. For example, web clients 304 can access the objects 108 for display within their respective user interfaces 112. Furthermore, crawler/indexer 102 can discover objects 108 on the web servers 302, and can then cause those objects to be indexed within index 110.

As depicted in FIG. 3, a search request may be executed across network 300. For example, a user may initiate a search request through user interface 112 of client 304. Client 304 transmits the request across network 300 to result display system 106. Result display system 106 may include request generator 114 (FIG. 1), or request generator 114 may be a distinct component and/or process. Request generator 114 generates an index query 116 (FIG. 1), which is further transmitted across network 300 to query engine 104. Query engine 104 accesses index 110 to retrieve a set of indexed objects 108 which are responsive to the search request. Query engine 104 then transmits a result set 118 (FIG. 1) to result display system 106. Result display system 106 then acts on result set 118 according to criteria which may include, for example, sorting, ranking, and/or normalization. Result display system 106 passes result set 118 to display engine 126 (FIG. 1). Display engine 126 transmits the information to client 304. Thus, client 304 receives the sorted, ranked, and/or normalized results from result display system 106. The output provided by result display system 106 is preferably, but not necessarily, an HTML web page that shows the sorted, ranked, and/or normalized results. These results can then be displayed within user interface 112. For example, user interface 112 can include a web browser configured to read the HTML output provided by result display system 106.

The selection of which components or processes are to be distributed across the network and/or of which components are to be collocated on the same device is generally an architectural design choice, but may be influenced by factors such as redundancy, speed, and cost. For example, crawler/indexer 102, query engine 104, result display system 106, index 110, and/or client 304 can be collocated on the same computer system, in which case they would not be connected to one another via network 300. Therefore, the architecture of search engine 100 may be networked or non-networked, or it may be consolidated or distributed.

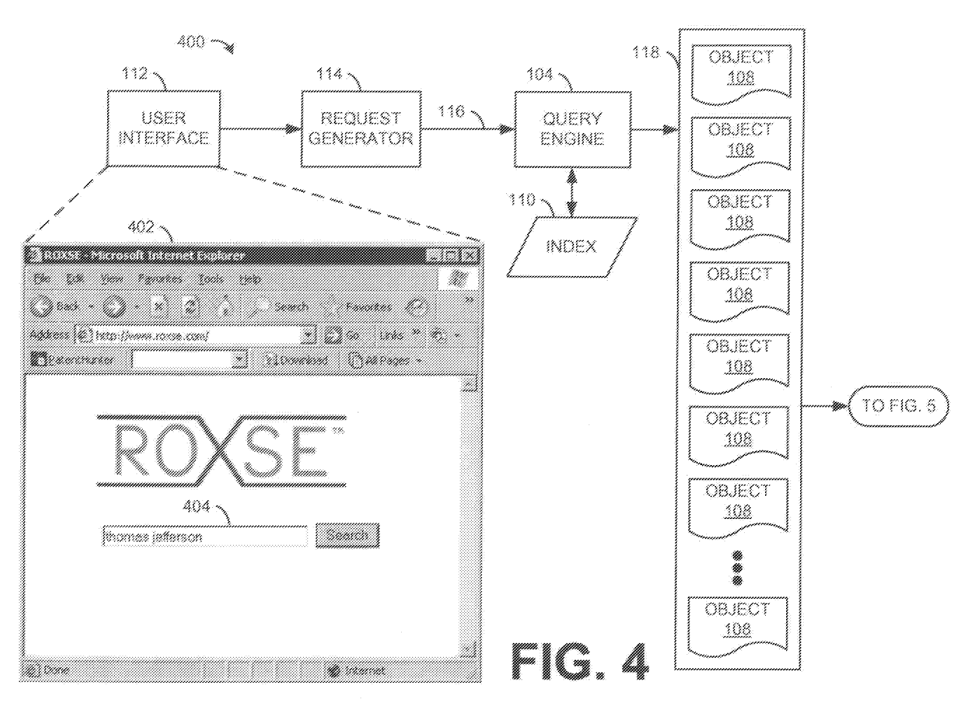

FIG. 4 depicts an exemplary data flow diagram 400 that provides a more detailed overview of the operation of the described search engine 100 (FIG. 1). The data flow diagram 400 also can represent various steps to be performed in embodiments of methods for providing sorted search results. As depicted by FIG. 4, user interface 112 provides an exemplary graphical user interface (GUI) 402 which could, for example, be displayed within a web browser executed on client 304 (FIG. 3). According to such an embodiment, the actual underlying web page depicted in GUI 402 may be output by, and provided to, client 304 by result display system 106 (FIG. 1). As depicted, GUI 402 includes a search term entry area 404 that is configured to receive a search request. The term “Thomas Jefferson” has been entered in search term entry area 404. The search term is then passed to request generator 114, which formulates the index query 116. Index query 116 is provided to query engine 104, which is used to access index 110 to generate the result set 118. Query engine 104 retrieves the most relevant results from index 110 in a result set 118. Result set 118 includes, therefore, a single group of the most relevant objects 108 found in index 110.

It should be understood that each instance of object 108 within result set 118 may include either the full contents of each object 108 or, according to some embodiments, only certain attributes of each object 108. For example, such attributes may include, but are not limited to, a file type, a keyword or keywords, cached information, a file name, and/or location information. Furthermore, as depicted in FIG. 4, result set 118 may provide objects 108 in any desired order, such as alphabetically, by web site, by date, by length, by number of occurrences of a search term or search terms, etc., or may simply provide the objects 108 in the order in which they are identified as meeting the search criteria.

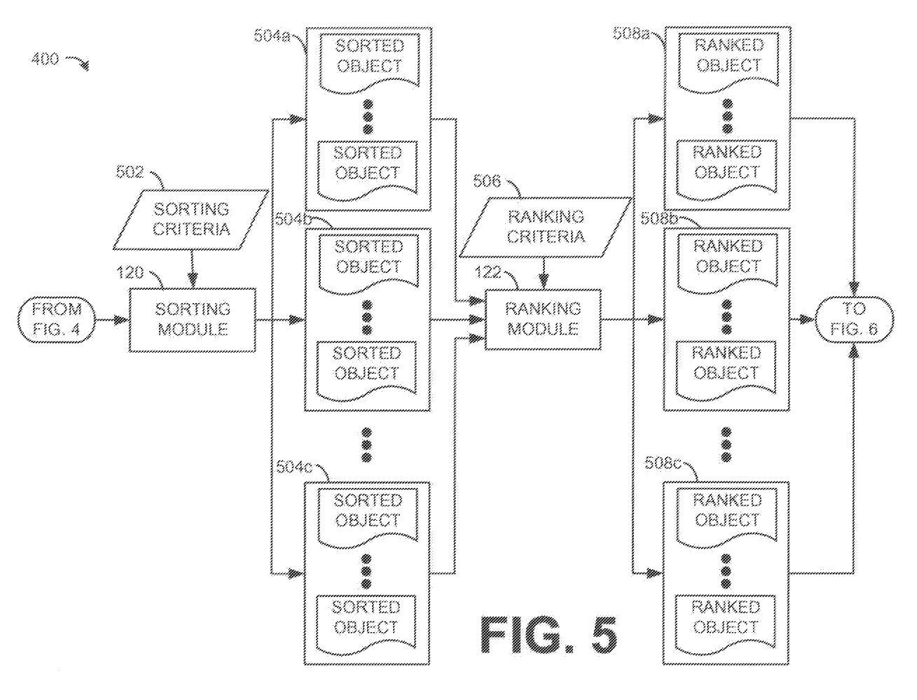

FIG. 5 depicts a continuation of exemplary data flow diagram 400. Unlike conventional search engines, which return and display search results based on a single criterion (e.g., the search term), embodiments of the disclosed search engine use additional criteria to sort result set 118 into distinct result groups 504a-504c based on sorting criteria 502. The failure of conventional search engines to segregate results can hinder the ability of a user to find desired information. That is, because conventional search engines do not sort results, a number of dissimilar interests are ultimately forced to compete with each other within the same single column of displayed results. This can result in the suppression of highly relevant content.

For example, a user of a search engine may be searching for information related to Thomas Jefferson (i.e., the third president of the United States) and, especially, an Adobe® Flash® video related to Thomas Jefferson. A search on the term “Thomas Jefferson” using a conventional search engine can, for example, provide a single column of search results ranging from history lessons, commercial web sites selling Thomas Jefferson memorabilia, links to online encyclopedias, pictures and descriptions of Thomas Jefferson's home, movies on Thomas Jefferson, the Thomas Jefferson School of Law, the Declaration of Independence, Thomas Jefferson quotations, Thomas Jefferson University, Thomas Jefferson University Hospital, Thomas Jefferson High School, as well as, potentially, Flash movies of Thomas Jefferson, among many other potential results.

Although a user may eventually find the desired Flash video using a conventional search engine, the user may have had to review numerous search results that are completely unrelated to Flash video. Furthermore, the desired result may be suppressed if Flash video is ranked very low among other types of results. Further, even if the relevant content is not actually suppressed, it may be effectively suppressed if, for example, it is placed far down the search result list. For example, the relevant content will be effectively suppressed if it is result number 758 out of 1000 results. Even if a user is searching on common phrases, such as, for example, “digital camera”, conventional search engines which rely on a single criterion may suppress relevant content.

According to some embodiments as depicted in FIG. 5, results display system 106 (FIG. 1) can be configured to sort objects 108 (FIG. 4) of result set 118 into two or more result groups. For example, the result set 118 (FIG. 4) can be segregated into two or more result groups 504a-504c according to a specified sorting criterion 502 using sorting module 120. Sorting criterion 502 may be user-selectable or it could be preconfigured within the logic of search engine 100.

Therefore, a user can search on “Thomas Jefferson”, but adding a sorting criterion for Flash web pages (i.e., web pages containing Flash video) causes the returned search results to be segregated into two groups: one group, which has Flash web pages; and another group, which has non-Flash web pages. According to some embodiments, the segregated results are then displayed in a manner which makes their segregation obvious to and/or convenient for the user, such as the objects 108 in the different result groups being displayed in different fields of a graphical display. For example, the objects 108 in the result group that includes Flash video can be provided in a first column and the objects 108 in the result group that does not include Flash video can be provided in a second column.

As another example, if a user is interested in Flash web pages and textual documents (for example, PostScript™, Microsoft™ Word, Portable Document Format (.pdf), WordPerfect™, text (.txt), etc.) related to Thomas Jefferson, the search results can be sorted into a first result group that includes Flash, a second result group that includes textual documents, and a third result group that does not include Flash or textual documents. Similar to the example above, some or all of the segregated results can then be displayed in different portions of a display tableau provided by display engine 126. For example, the objects in the result group that includes Flash video can be provided in a first column, the objects in the result group that includes textual documents can be provided in a second column, and the objects in the result group that does not include Flash video or textual documents can be provided in a third column. Although columns are used in this example, the results could be displayed in other ways and in other distinct portions of the display tableau. In one embodiment the sorting logic could be configured to provide a column which displays a result group having both Flash video and textual documents. In another embodiment, the sorting logic could be configured to provide a column which displays a result group having Flash video documents, but not having textual documents, or vice versa. Such a column could be provided in addition to, or in lieu of, the first and/or second column mentioned above.

Therefore, as exemplified above, some embodiments of the present disclosure allow for the properties of object 108 to be utilized as sorting criteria 502. Such properties may include, but are not limited to, for example, the file type (e.g., “doc”, “txt”, “pdf”, “avi”, “bmp”, “jpeg”, etc.), the URL syntax (e.g., “http”, “https”, “ftp”, “com”, “gov”, “info”, etc.), and other content which may be indicative of logical encoding or logical relationships.

According to one example, the result set 118 can be sorted into a first result group which shows a relationship to a web site or web server configured for online security, and a second result group which does not show a relationship to a web site or web server configured for online security. Nonsecure content is transmitted over the Internet utilizing, for example, the Hypertext Transfer Protocol (HTTP). Secure content is transmitted over the Internet using, for example, the Secure Hypertext Transfer Protocol (HTTPS). Both protocols use similar schemes for accessing online resources, but the HTTPS protocol uses a differentiated network port and an additional encryption layer as a means of implementing online security. The additional encryption layer may be implemented, for example, through the Secure Sockets Layer (SSL) or Transport Layer Security (TLS). Because of the differentiation between nonsecure content and secure content, it is convenient to associate nonsecure content with “nonsecure web pages” and secure content with “secure web pages”, although this association does not limit the nature of the content to, for example, a web page. However, because secure web pages utilize the HTTPS protocol to exchange network traffic, they are often associated with commercial web sites where online payment transactions may occur. Furthermore, because of the technical relationship that most secure web sites have with the HTTPS protocol, the discernment between secure web sites and nonsecure web sites is readily facilitated by analysis of the URL syntax. Most secure web sites have an “https” syntax and most nonsecure web sites have an “http” syntax. Thus, sorting module 120 can be configured to sort the search results in result set 118 based on an analysis of the URL syntax for a sense of security (e.g., either “http” or “https”) and in so doing, produce a result group which may, for example, be indicative of other interests beyond security, such as, for example, online commerce where payment transactions may occur. Such a configuration may produce two fields of displayed results, a first field for a result group of secure web sites and a second field for a result group of nonsecure web sites.

Sorting module 120 can be further configured to sort the result set into noncommercial groups and commercial groups. A commercial result is a web site determined to be engaged in online commerce. A noncommercial result is a web site determined not to be engaged in online commerce. Online commerce is defined in terms of certain configurations, in particular: (1) a capability to accept online payments or otherwise conduct online financial transactions; or (2) the presence of a link or links to an external web site which itself has a capability to accept online payments or otherwise conduct online financial transactions. Therefore, one embodiment conducts a sort based on the criterion of whether a web site is configured for online commerce. If so, then the web site can be sorted into the commercial group. If not, then the web site can be sorted into the noncommercial group. Such configurations may produce two fields of displayed results, a first field for commercial web sites and a second field for noncommercial web sites.

Whether a result is ultimately sorted into a result group of commercial results or a result group of noncommercial results can be based on a variety of criteria. For example, secure web sites are often used to process financial transactions, so the analysis of sorting module 120 could comprise segregating result set 118 into a result group of web sites that are secure and a result group of web sites that are not secure. Another analysis may determine whether the web site is configured to process online financial transactions, such as credit card transactions, automated bank account deduction systems (e.g., PayPal®, Google® Checkout, etc.), and/or automated virtual check draft systems. Other analysis may look for keywords, terms, or data input fields in the actual content of the web page, such as, but not limited to, “pay here”, “price”, “quantity”, “add to shopping cart”, “check out”, “name”, “address”, “shipping”, etc. Still another analysis may look for a form field which is preceded by or associated with a currency symbol, such as $, £, ¥, etc.

According to some embodiments, a determination of commercialism relates to published content served from a unique source and is transparent to a distinction between a web page and a web site. A unique source could be identifiable hardware, such as a server, or it could be identifiable content, such as a web page or a web site. Thus, if a particular web page is determined to be commercial, then that determination may cause all published content from an entire web site to be commercial as well. Furthermore, if a web site is determined to be commercial, then all constituent web pages may be commercial by default. For example, a web page comprising product information from Buy.com (http://www.buy.com/) may be sorted as a commercial result if at least one other constituent web page within the web site, such as a checkout page, is determined to be commercial, or if the entire web site shows an apparent intent to engage in online commerce. By this example, all web pages within the Buy.com web site, including the exemplary product information page, would be displayed as commercial results. According to another example, if a domain name hosts a web page or web site determined to be commercial, then the domain name itself may be categorized as commercial. For example, if the Government Printing Office (http://www.gpo.gov/, where “gpo.gov” constitutes a domain name) hosts a web site for the Government Bookstore (http://bookstore.gpo.gov/), and if the bookstore web site is determined to be commercial, then all published content served from the “gpo.gov” domain may be categorized as commercial. It should be understood that these are merely examples and that there may be a vast number of variables which could be used to determine whether or not a unique source of published content is commercial. Additionally, according to another embodiment, a user may override the sort routine by specifying that a particular web site is to be treated as a commercial object, or as a noncommercial object. For example, the United States Patent & Trademark Office (USPTO) accepts payment for various fees by credit card and might, under some sorting criteria, be classified as a commercial web site. The USPTO web site, however, has a wealth of information regarding law, technology, and trademarks. Therefore, a user who regularly searches for information on technology may desire to designate the USPTO web site as a noncommercial web site. This override may only be for a particular search, or may stay in effect until it is changed by the user.

However, regardless of the method used, according to embodiments of the present disclosure, the objects 108 in result set 118 are sorted, grouped or otherwise categorized into definitive categories (e.g., result groups 504a-504c) based on one or more analyses. The results of these analyses, which could be weighted according to importance, can be used to determine the likelihood that the object 108 falls into a particular category. Objects 108 satisfying a predetermined or user configurable threshold are then sorted into a first result group, while the others are sorted into a second result group.

According to another embodiment using sorting criteria 502 (FIG. 5), result set 118 can be sorted into a first result group that comprises HTML encoded documents and a second result group that comprises Portable Document File (“pdf”) documents. This embodiment could also be extended to the entire range of file formats, types, and extensions, such as those referred to elsewhere in this disclosure, and which includes, for example, Microsoft Word documents (“doc”), PostScript files (“ps”), and Microsoft Excel files (“xls”), among others. Furthermore, this embodiment is not limited to sorting into only two result groups, but could also be sorted into any number of result groups 504a-504c. For example, among sorted objects 504a-504c, a first result group might comprise PDF files, a second result group might comprise DOC files, and a third result group might comprise PS files. Additionally, a fourth result group could include results that are “negative”, that is, results which do not fall into any of the first three result groups (i.e., not PDF, not DOC, and not PS). It will be appreciated from the above that the sorting criteria need not be single terms, but can be terms related by Boolean logic, such as, (“doc” or “PS”) ANDNOT “xls” ANDNOT “commercial”. Thus, content can be located using desired search terms, for example, “mortgage” AND “home”, and sorted using another desired sorting criteria, for example, “noncommercial” and “xls” so as to, for example, quickly locate a noncommercial web page which provides a repayment spreadsheet for a home mortgage.

Further, computational numerical analysis (CNA) is a potentially useful way to search for content on the web. CNA has applications in many fields (e.g., stock market analysis, life science, meteorology, computer science, astronomy, mathematics, engineering, etc.) and therefore could be of widespread and diffuse interest to search engine users. Accordingly, the sorting criteria 502 used by sorting module 120 can specify that objects 108 be grouped based on whether or not the objects 108 comprise CNA properties. For example, CNA can be detected by determining which objects 108 include logical code from a programming language, such as Java enabled web pages, among other possibilities. As with file formats, the number of programming languages is vast, and new programming languages appear on a regular basis. However, for example, sorting module 120 can be configured to sort objects 108 based on whether these objects 108 include, or are enabled by, code written in a particular programming language such as, for example, Java, FORTRAN, Pascal, Python, C, and C++, among others. Accordingly, sorting module 120 can be configured, for example, to sort objects 108 into two groups of published content, wherein a first result group is enabled by Java code and a second result group is not enabled by Java code. Similarly, sorting module 120 can be configured to sort objects 108 into a first result group of Java enabled documents and a second result group of typical office application files, such as files associated with spreadsheets and/or word processors.

According to some embodiments, the sorting criteria 502 could have a basis in the type of server software resident on a server. For example, published content served from Microsoft® Windows® based web servers could be segregated from published content served from Linux based servers. The sorting criteria could also be web pages that display (or can otherwise prove) membership in eTrust or the Better Business Bureau, among other consumer protection programs.

According to some embodiments, the sorting criteria 502 used by sorting module 120 can have a basis in logical relationships between groups. For example, such a relationship can occur whenever a file (e.g., “doc”, “pdf”, “ps”, “avi”, “mpeg”, “jpeg”, etc.) is served from a particular host web site. In this case, the file and the host enjoy a unique, one-to-one relationship which is potentially useful to users who desire information regarding where files are located. Thus, sorting module 120 may sort files into a first result group while sorting the unique web pages that served, or hosted, those files into a second result group. The files and hosting web pages may then be displayed in a manner which shows their relationship. For example, the results may be displayed in individual columns and in the same row such that an obvious linear correspondence is visually evident between a file and its host.

According to another embodiment of sorting based on relationships, sorting module 120 can sort the results based on the file type. For example, a user may want to identify files having the same content, but in different formats. Thus, sorting module 120 can, for example, identify results in result set 118 that are believed to include the similar content, but are provided in different file formats. Sorting module 120 can then, for example, sort the results based on the file type. For example, PDF files, Microsoft Word files, and PostScript files can be sorted into three different result groups. Similarly, according to another example, image files in different formats could be grouped based on the file type. For example, a photograph may be found in JPEG, GIF, and TIFF formats on the web. Sorting module 120 can be used to identify this image and sort the image into result groups based on the file type. A similar approach can be used for video files, sorting them into, for example, MPEG, MPEG-2, and/or MPEG-4 result groups. The types of files sorting module 120 sorts on could also be intermixed. For example, sorting module 120 may sort based on video and on one or more layers of audio. Such a combination of audio and video could, for example, comprise audio and video tracks of a multimedia presentation.

Although sorting the result set 118 into distinct result groups 504a-504c generally enhances the search for relevant content, it may still be beneficial to find the most relevant content within these result groups. Thus, according to some embodiments, once result set 118 is sorted into result groups 504a-504c, the objects within these result groups can be ranked by ranking module 122. The ranking may be performed based on ranking criteria 506. Ranking module 122 uses ranking criteria 506 to rank the objects within each of the result groups to produce result groups 508a-508c which comprise listings of ranked objects. For example, ranking module 122 may use as ranking criteria 506 past user search history, analysis of keyword locations, analysis of hyperlinks, or frequency of keywords, among other methods. Display engine 126 (FIG. 1) can use the rankings to provide an output such that the results that have been determined to be the most relevant are displayed in a desired fashion. For example, if the results are displayed in columns, it may be desirable to display the most relevant (e.g., highest ranked) results at the top of the columns.

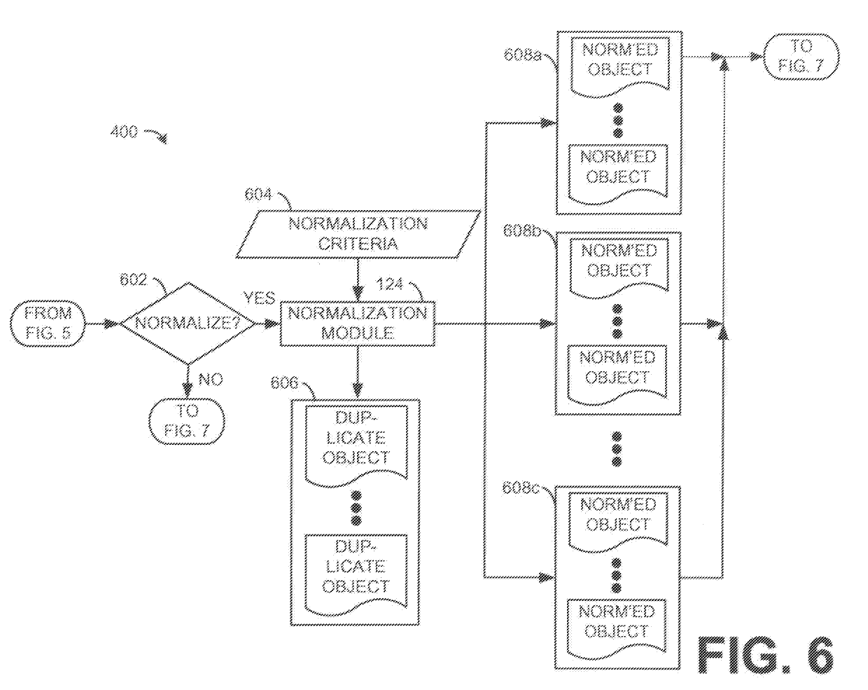

FIG. 6 is a continuation of the data flow diagram 400 of FIGS. 4 and 5. At decision block 602, search engine 100 determines whether to normalize the result groups of ranked objects 508a (FIG. 5). In this context, normalization can refer to the elimination of redundancy among search results based on the domain name, such as “roxse.com,” “whitehouse.gov,” or “yahoo.com.” Because a domain name often identifies an organization, it may be useful to eliminate redundant domain names from displayed results. Thus, normalization based on the domain name implies that one, and only one, occurrence of any one particular domain name will be retained in the search result groups. Assuming multiple search results are returned from a particular domain name, normalization module 124 may use normalization criteria 604 to make a determination to retain one result and discard the rest. This determination could be based on ranking, such as, for example, whichever result appears first in the ranking.

In one embodiment, the results are normalized within a result group. That is, the domain name will only appear once in a result group, regardless of how many web pages under that domain name occur in the result set 118. In another embodiment, the results are normalized between the result groups. That is, the domain name can only appear in one result group, even if some pages might also fall into another result group. In still another embodiment, the results are normalized between the result groups and also within a result group, two or more result groups, or all the result groups. In another embodiment, the user can enable, disable, or modify the normalization procedure. For example, the user could specify that a particular domain name is not to be normalized, and therefore multiple web pages under that domain name may appear within a result group, or even, if desired, in different result groups. Preferably, a domain name can only appear in one result group, and only once in that result group.

Once the results have been sorted, ranked, and potentially normalized, display engine 126 can be used to output the results into an appropriate format for display within a user interface 112. According to some embodiments, the determination (e.g., block 602) of whether to normalize search results can either be user-selectable or it can be preconfigured. If the determination is user-selectable, then the user is given the option of whether to normalize search results. If the determination is preconfigured, then the search results are either normalized or not normalized according to the search engine's preset configuration and the user has no option. In other embodiments, the decision to normalize may be made based on the result set 118 itself. For example, if a particular result group includes less than a predetermined number of objects, this result group may not be normalized, while result groups having more than the predetermined number of objects are normalized. Hence, according to some embodiments, some result groups 508a-508c (FIG. 5) can be normalized while others are not.

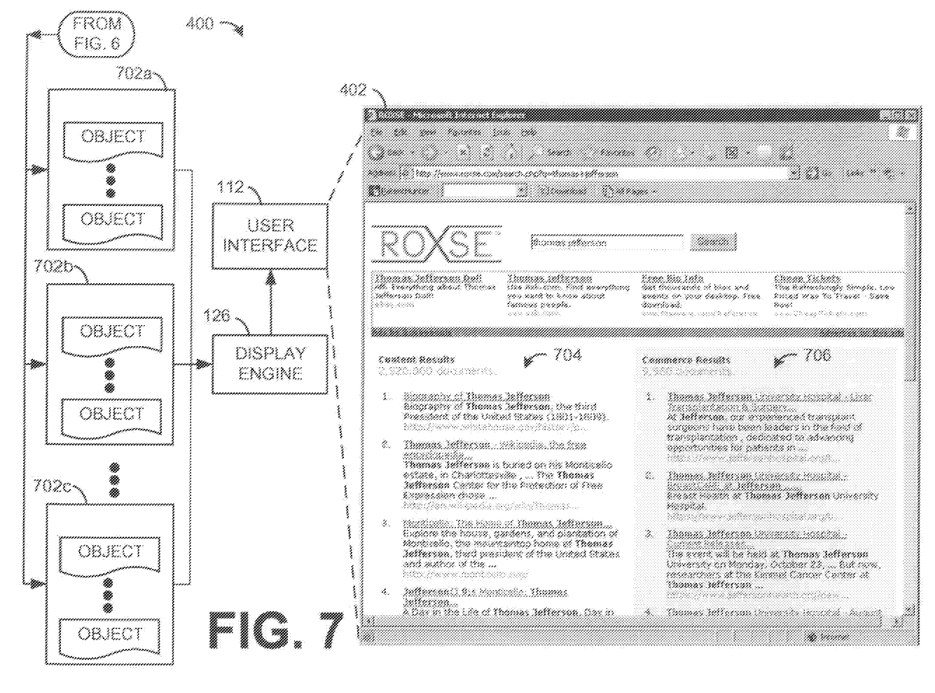

If the result groups 508a-508c are not to be normalized, then the data flow diagram moves to FIG. 7, which will be described in more detail below. However, if the result groups are to be normalized, the result groups are provided to normalization module 124. Normalization module 124 uses normalization criteria 604 to normalize the data as described above. Normalization module 124 thus produces result groups 608a-608c which contain listings of objects which have been sorted, ranked and normalized. During the normalization process, duplicate objects can be grouped into their own result group 606. Group 606 could be discarded or it could be saved in the event that a user desires to see the duplicate objects after viewing the initial results.

FIG. 7 is a continuation of the data flow diagram 400 of FIGS. 4-6 and shows one example of how display engine 126 can provide a variety of displays to user interface 112 after receiving result groups 702a-702c as input. Result groups 702a-702c can represent: (1) the sorted and the ranked result groups 508a-508c of FIG. 5; or (2) the sorted, ranked and normalized result groups 608a-608c of FIG. 6. In either case, result groups 702a-702c can be provided to the display engine 126 as input. Display engine 126 is configured to format the result groups for display within user interface 112, which comprises the GUI 402. Display engine 126 can be configured to provide an output that causes the results to be displayed in various formats that differentiate each of the result groups 702a-702c. For example, a web page can be generated that causes the display of the results in multiple columns, such as those depicted in GUI 402 as columns 704 and 706. It should be understood that display engine 126 can be configured to generate an output that provides for the display of less than all of the result groups 702a-702c. For example, sorting module 120 may sort objects into a first result group of PDF files, a second result group of PostScript files, and a third result group containing all other objects. In such a configuration, display engine 126 can provide output that causes two of these result groups, such as the first result group of PDF files and the second result group of PostScript files, to be displayed while suppressing from display the third result group of all other objects.

In FIG. 7, GUI 402 exemplifies a possible graphical display of search results generated by display engine 126 and presented within user interface 126. By this example, a first column 704 labeled “Content Results”, and a second column 706 labeled “Commerce Results”, are depicted. Both columns show the sorted, ranked, and potentially normalized results of two result groups, a first result group (“content”) which can show results determined not to be commercial, and a second result group (“commerce”) which can show results determined to be commercial. According to this example, both columns can be located in graphically distinct portions of GUI 402 which are side by side.

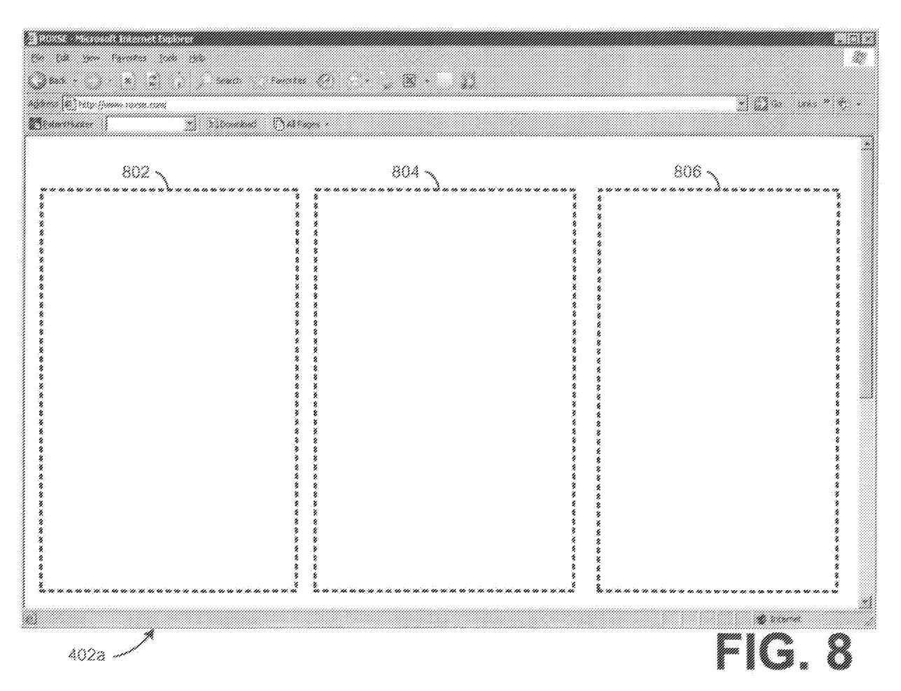

FIG. 8 depicts another embodiment of a GUI 402a that can be generated by display engine 126 and presented within user interface 112. Specifically, like GUI 402 of FIG. 7, the result groups are displayed in columns. However, GUI 402a can include three or more columns of results depending on the total number of result groups to be displayed. Thus, a first result group can be depicted in a first column 802, a second result group can be depicted in a second column 804, and a third result group can be depicted in a third column 806.

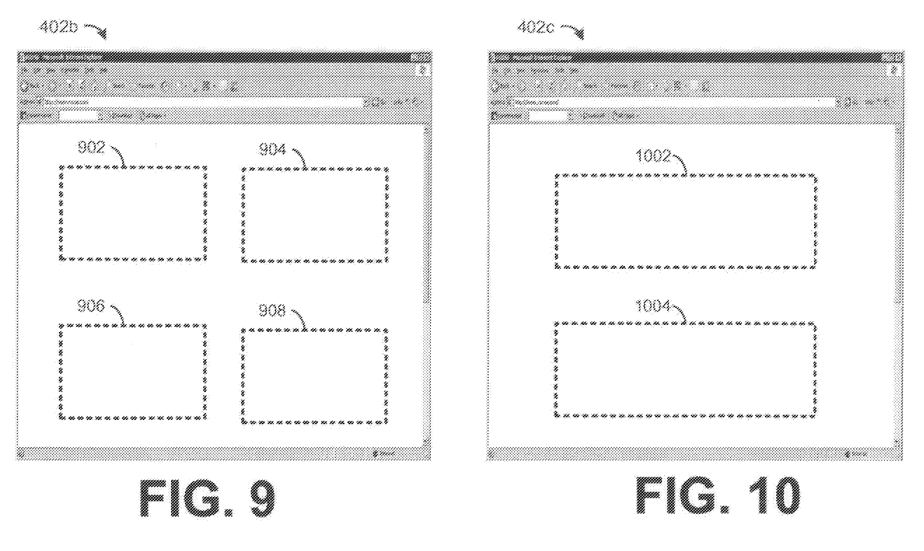

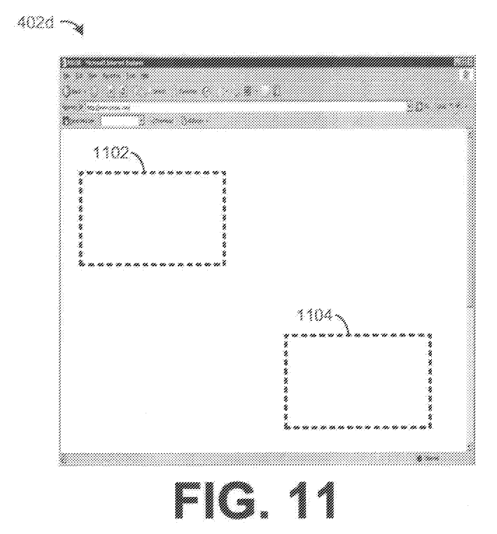

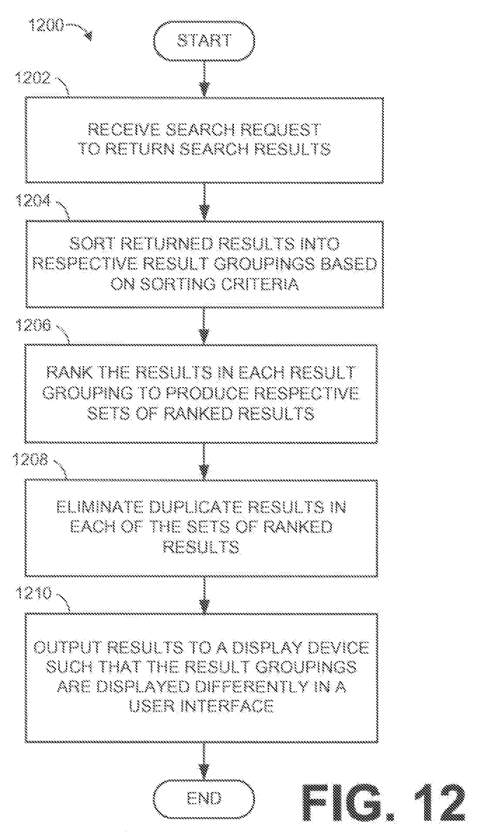

The embodiments described herein are not limited to columnar graphical display. For example, FIGS. 9 and 10 depict additional embodiments of a GUI 402b and 402c, respectively, in which the results are displayed in various positions about the user interface 112. For example, FIG. 9 depicts a GUI 402b in which the results can be grouped and positioned in numerous rows and columns. For example, four result groups are displayed in respective portions 902, 904, 906, and 908 of GUI 402b. Similarly, GUI 402c of FIG. 10 exemplifies two or more result groups displayed in respective rows, such as those formed by portions 1002 and 1004. FIG. 11 depicts yet another GUI 402d in which the result groups are displayed in different portions of the screen that do not necessarily correspond to rows and/or columns. It should be understood that the examples provided by FIGS. 7-11 are not limiting and that any number of relative positions and variations between result groups are possible.

In still another embodiment, not shown, the sorted (and normalized if desired) search results are not initially presented. Rather, a plurality of descriptive links or commands to the system 200 is provided. For example, one link or command may indicate “search results with DOC”, another link or command may indicate “search results with WPD”, another may indicate “search results with TXT”, another may indicate “search results with PDF”, another may indicate “search results with TIFF”, and still another may indicate “other search results”. Thus, rather than the display being crowded or confusing with links to numerous web pages or web sites, the display indicates that results are available for the various criteria and provides links or commands to obtain the results for each of the various criteria. The user can then click on the link or command and the system 200 will provide the specified search results for display to the user. This embodiment is especially useful when the user has specified numerous sorting criteria, is visually-impaired and uses a large-font screen display, and/or is using a device with a small screen area, such as a personal digital assistant or cellphone. For example, the boxes 902, 904, 906 and 908 in FIG. 9, and the boxes 1002 and 1004 in FIG. 10 could, rather than displaying results, indicate the type of result and provide a link or command to the system 200 to provide that type of result. The system 200 could also provide those results, along with the display, so that the results are resident on the user's computer and clicking on a link or command accesses those results on the user's computer, rather than requesting that the system 200 provide them at that time.

FIG. 12 is a flow chart 1200 of an exemplary process for providing sorted search results. At block 1202, a search request is received. For example, the search request can comprise one or more keywords. At block 1204, the result set 118 is sorted into result groups based on sorting criteria as described in detail above. At block 1206, the objects in a result group are ranked to produce a ranked result group. This is preferably, but not necessarily, performed for each result group. At block 1208, duplicate results in a ranked result group are eliminated to provide a normalized ranked result group. This is preferably, but not necessarily, performed for each result group. At block 1210, results are output to a display device such that at least a portion of a result group is displayed differently in a user interface than a portion of another result group. Preferably, at least a portion of each of the normalized ranked result groups is displayed. For example, HTML code, or another type of computer readable output, may be generated. This computer readable output can then be read by and displayed within a graphical user interface within a display device. For example, the display device can be associated with a client 304 (FIG. 3).

In one embodiment, the sorting criteria are fixed and predefined. For example, the search results are always sorted into commercial or noncommercial categories. In another embodiment, the sorting criteria are predefined, but there is a plurality of predefined sorting criteria, such as, but not limited to: commercial or noncommercial; secure or nonsecure; Flash or non-Flash; text or non-text; etc. In this embodiment, the searcher would, in addition to specifying the search terms, select one of the predefined sorting criteria. In still another embodiment, the searcher may define and store the sorting criteria for future use. For example, the searcher could specify the criteria for “commercial” and then store that criteria, specify the criteria for “text” and then store that criteria, etc. Thus, in a future search, the searcher could specify the search terms and also select one of the stored sorting criteria, thereby saving time which might otherwise have been invested in recalling and/or re-entering the desired sorting criteria. In still another embodiment the searcher may combine two or more predefined or stored sorting criteria. For example, there may be a combination of predefined sorting criteria, user-defined sorting criteria, and stored sorting criteria.

Any process descriptions, steps, or blocks in the flow or data flow diagrams described herein and/or depicted in the attached figures should be understood as potentially representing modules, segments, or portions of code which include one or more executable instructions for implementing specific logical functions or steps in the process. Alternate implementations are included within the scope of the preferred embodiments of the systems and methods described herein in which steps or functions may be deleted, executed out of order from that shown or discussed, executed concurrently, substantially concurrently, or sequentially, or in reverse order, depending on the functionality involved.

Conditional language, such as, among others, “can”, “could”, “might”, or “may”, unless specifically stated otherwise, or otherwise understood within the context as used, is generally intended to convey that certain embodiments optionally could include, while some other embodiments do not include, certain features, elements and/or steps. Thus, such conditional language indicates, in general, that those features, elements and/or step are not required for every implementation or embodiment.

Various valuable aspects, benefits, capabilities, embodiments and/or features have been described above which are not available in the prior art. Further, these various aspects, benefits, capabilities, embodiments and/or features may be used independently or in combination, as appropriate to achieve a desired result; it is not necessary to incorporate every aspect, benefit, capability, embodiment and/or feature into a single implementation in order to obtain specific desired aspects, benefits, capabilities, and/or features.

Other variations of these aspects, benefits, capabilities, embodiments and/or features will suggest themselves to those of skill in the field upon examination of the drawings and detailed description and all such variations are included within the scope of the present invention, as defined by the accompanying claims. Therefore, the scope of the present invention is to be determined only by the claims.

I claim:

1. A method comprising:
receiving a search request based on at least one keyword;
obtaining search results based on the at least one keyword;
sorting the obtained search results into at least two result groups based on sorting criteria; and
outputting at least a portion of the at least two result groups to a display device such that the outputted portions of the at least two result groups are displayed differently from each other in a user interface.

2. The method of claim 1 wherein the outputted portions of the at least two result groups are displayed differently from each other by simultaneously displaying at least a portion of the sorted results for the at least two result groups in different portions of the user interface.

3. The method of claim 1, further comprising:
ranking the results in each result group to produce respective sets of ranked results; and
wherein outputting at least a portion of the at least two result groups to a display device comprises outputting at least a portion of each of the sets of ranked results.

4. The method of claim 3, further comprising:
eliminating duplicate results in at least one of the sets of ranked results prior to outputting at least a portion of the at least two result groups to a display device.

5. The method of claim 4, wherein eliminating duplicate results comprises:
determining whether at least two results in the at least one set of ranked results are associated with a uniform resource locator (URL) comprising the same domain name level identifier;
selecting one of the at least two results that have the same domain name level identifier; and
outputting the results to the display device such that the one of the at least two results is displayed in the user interface and at least one other one of the at least two results is not displayed in the user interface.

6. The method of claim 4, wherein the domain name level is the second level domain name.

7. The method of claim 3, wherein outputting at least a portion of each of the sets of ranked results comprises:
outputting the results to the display device such that the at least a portion of the first set of ranked results is displayed in a first column in the user interface; and
outputting the results to the display device such that the at least a portion of the second set of ranked results is displayed in a second column in the user interface.

8. The method of claim 1, wherein the at least two results groups have at least one of the following object relations:
(a) a secure web site or a nonsecure web site;
(b) a commercial web site or a noncommercial web site;
(c) a content web site or a commerce web site;
(d) a first file-type or a second file-type of a plurality of file-types, the second file-type being different than the first file-type; or
(e) a web site that does not include computational analysis or a web site that does have computational analysis.

9. The method of claim 8, wherein the plurality of file-types comprises at least two of the following: a word processing file, a spreadsheet file, an audio file, a video file, a multimedia file, an image file, or a web site.

10. The method of claim 1, wherein sorting the returned results into at least two result groups comprises:
analyzing content of a returned result based upon the sorting criteria to determine into which of the result groups to place the returned result; and
placing the returned result into one of the at least two result groups based on analyzing the content.

11. The method of claim 10 wherein the content of each of the returned results is analyzed and each returned result is placed into one of the at least two result groups.

12. The method of claim 1, wherein sorting the returned results into at least two result groups comprises:
analyzing a portion of a uniform resource locator (URL) associated with a returned result to determine into which of the result groups to place the returned result; and
placing the returned result into one of the at least two result groups based on analyzing the URL.

13. The method of claim 1 wherein a result group comprises an indicator for that result group and sorted search results for that result group, and wherein the outputted portions are displayed differently from each other by simultaneously displaying the indicators for the at least two result groups in different portions of the user interface.

14. A computer-readable medium having a computer program comprising:
logic configured to receive a search request based on at least one keyword;
logic configured to obtain search results based on the at least one keyword;
logic configured to sort the obtained results into at least two result groups based on sorting criteria; and
logic configured to output at least a portion of the at least two result groups to a display device such that the outputted portions of the at least two result groups are displayed differently from each other in a user interface.

15. The computer-readable medium of claim 14 wherein the logic configured to output at least a portion of the at least two result groups is configured to display the outputted portions of the at least two result groups differently by outputting at least a portion of the search results for the at least two result groups such that the outputted search results for the at least two result groups are simultaneously displayed in different portions of the user interface.

16. The computer-readable medium of claim 14, further comprising:
logic configured to rank the results in each result group to produce respective sets of ranked results; and
wherein the logic configured to output at least a portion of the at least two results groups is configured to output at least a portion of each of the sets of ranked results.

17. The computer-readable medium of claim 16, further comprising:
logic configured to eliminate duplicate results in at least one of the sets of ranked results prior to outputting at least a portion of the at least two results groups to the user interface.

18. The computer-readable medium of claim 17, wherein the logic configured to eliminate duplicate results comprises:
logic configured to determine whether at least two results in the at least one set of ranked results are associated with a uniform resource locator (URL) comprising the same domain name level identifier;
logic configured to select one of the at least two results that have the same domain name level identifier; and
logic configured to output the results to the display device such that the one of the at least two results is displayed the user interface and at least one other one of the at least two results is not displayed in the user interface.

19. The computer-readable medium of claim 16, wherein the logic configured to output at least a portion of each of the sets of ranked results comprises:
logic configured to output the results to the display device such that the at least a portion of the first set of ranked results is displayed in a first column in the user interface; and
logic configured to output the results to the display device such that the at least a portion of the second set of ranked results is displayed in a second column in the user interface.

20. The computer-readable medium of claim 14, wherein the logic configured to sort the obtained search results is configured to sort based upon at least one of the following object relations:
(a) a secure web site or a nonsecure web site;
(b) a commercial web site or a noncommercial web site;
(c) a content web site or a commerce web site;
(d) a first file-type or a second file-type of a plurality of file-types, the second file-type being different than the first file-type; or
(e) a web site that does not include computational analysis or a web site that does have computational analysis.

21. The computer-readable medium of claim 20, wherein the logic configured to sort the obtained search results is configured to sort based upon at least two of the following file types of the plurality of file-types: a word processing file, a spreadsheet file, an audio file, a video file, a multimedia file, an image file, or a web site.

22. The computer-readable medium of claim 14, wherein the logic configured to sort the returned results into at least two result groups comprises:
logic configured to analyze content of a returned result based upon the sorting criteria to determine into which of the result groups to place the returned result; and
logic configured to place the returned result into one of the at least two result groups based on analyzing the content.

23. The computer-readable medium of claim 22 wherein the content of each of the returned results is analyzed and each returned result is placed into one of the at least two result groups.

24. The computer-readable medium of claim 14 wherein the logic configured to sort the returned results into at least two result groups comprises:
logic configured to analyze a portion of a uniform resource locator (URL) associated with a returned result to determine into which of the result groups to place the returned result; and
logic configured to place the returned result into one of the at least two result groups based on the analysis of the URL.

25. The computer readable medium of claim 14 wherein a result group comprises an indicator for that result group and sorted search results for that result group, and wherein the logic configured to output at least a portion of the at least two result groups is configured to display the outputted portions of the at least two result groups differently by simultaneously displaying the indicators for the at least two result groups in different portions of the user interface.

26. A search engine system comprising:
means for receiving a search request based on at least one keyword;
means for obtaining search results based on the at least one keyword;
means for sorting the obtained search results into at least two result groups based on sorting criteria; and
means for outputting at least a portion of the at least two result groups to a display device such that the outputted portions of the at least two result groups are displayed differently from each other in a user interface.

27. The system of claim 26 wherein the means for outputting at least a portion of the at least two result groups differently comprises means for outputting at least a portion of the search results for the at least two result groups such that the outputted search results for the at least two result groups are simultaneously displayed in different portions of the user interface.

28. The system of claim 26, further comprising:
means for ranking the results in each result group to produce respective sets of ranked results; and
wherein the means for outputting at least a portion of the at least two result groups comprises means for outputting at least a portion of each of the sets of ranked results.

29. The system of claim 28, further comprising:
means for eliminating duplicate results in at least one of the sets of ranked results.

30. The system of claim 29, wherein the means for eliminating duplicate results comprises:
means for determining whether at least two results the at least one set of ranked results are associated with a uniform resource locator (URL) comprising the same domain name level identifier;
means for selecting one of the at least two results that have the same domain name level identifier; and
means for outputting the results to the display device such that the one of the at least two results is displayed in the user interface and at least one other of the at least two results is not displayed in the user interface.

31. The system of claim 28, wherein the means for outputting at least a portion of each of the sets of ranked results to the display device comprises:
means for outputting the results to the display device such that the at least a portion of the first set of ranked results is displayed in a first column in the user interface; and
means for outputting the results to the display device such that the at least a portion of the second set of ranked results is displayed in a second column in the user interface.

32. The system of claim 26, wherein the means for sorting the obtained search results comprises means for sorting based upon at least one of the following object relations:
(a) a secure web site or a nonsecure web site;
(b) a commercial web site or a noncommercial web site;
(c) a content web site or a commerce web site;
(d) a first file-type or a second file-type of a plurality of file-types, the second file-type being different than the first file-type; or
(e) a web site that does not include computational analysis or a web site that does have computational analysis.

33. The system of claim 32, wherein the means for sorting based upon the object relations comprises means for sorting based upon at least two of the following file types of the plurality of file-types: a word processing file, a spreadsheet file, an audio file, a video file, a multimedia file, an image file, or a web site.

34. The system of claim 26, wherein the means for sorting the returned results into at least two result groups comprises:
means for analyzing content of a returned result based upon the sorting criteria to determine into which of the result groups to place the returned result; and
means for placing the returned result into one of the at least two result groups based on analyzing the content.

35. The system of claim 34 wherein the content of each of the returned results is analyzed and each returned result is placed into one of the at least two result groups.

36. The system of claim 26 wherein means for sorting the returned results into at least two result groups comprises:
means for analyzing a portion of a uniform resource locator (URL) associated with a returned result to determine into which of the result groups to place the returned result; and
means for placing the returned result into one of the at least two result groups based on the analysis of the URL.

37. The system of claim 26 wherein a result group comprises an indicator for that result group and sorted search results for that result group, and wherein the means for outputting at least a portion of the at least two result groups comprises means for outputting the indicators for the at least two result groups such that the indicators for the at least two result groups are simultaneously displayed in different portions of the user interface.
